(19) United States
(12) Patent Application Publication
(10) Pub. No.: US 2024/0203217 A1
(43) Pub. Date: Jun. 20, 2024

(54) Product Verification System

(71) Applicant: ZEBRA TECHNOLOGIES CORPORATION, Lincolnshire, IL (US)

(72) Inventors: Darran Michael Handshaw, Sound Beach, NY (US); Edward Barkan, Miller Place, NY (US); Anders Gustafsson, Lincolnshire, IL (US)

(21) Appl. No.: 18/083,280

(22) Filed: Dec. 16, 2022

(51) Int. Cl. G07G 3/00; G06V 20/52; G07G 1/00; H04N 23/90

(52) U.S. Cl. CPC G07G 3/003; G06V 20/52; G07G 1/0036; H04N 23/90; G06K 7/10297

(57) ABSTRACT

A product verification system for use in bagging areas is disclosed herein. An example product verification system includes a first imaging device having a first field of view (FOV) and a second imaging device having a second FOV. One or more processors of the system are configured to capture first image data from the first imaging device, and identify within the first image data one or more unloaded objects. The processors may also capture second image data from the second imaging device, and identify within the second image data one or more objects entering a loading plane. The processors may also identify identifying characteristics of the one or more objects entering the loading plane, and obtain identification data for the unloaded objects from the unloading plane. The processors may compare the identification data to the identifying characteristics to determine if each of the unloaded objects has entered the loading plane.

### BACKGROUND

Barcode scanning devices that include visual imaging systems are commonly utilized in many retail and other locations. Such devices are typically used to facilitate customer checkout, where product verification can prove challenging. Conventional barcode scanning devices commonly experience issues with product verification, as their imaging capabilities and/or field of view (FOV) limit the amount of information they can obtain.

For example, conventional barcode scanning devices are commonly circumvented and/or tricked by users that avoid scanning objects by passing the objects around the device FOV or obscuring the object's indicia (e.g., barcode). Conventional barcode scanning devices typically struggle to detect objects obtained through such scan avoidance, as they are generally unable to verify that products loaded into a bag have not been scanned. Consequently, conventional barcode scanning devices suffer from issues that cause such conventional devices to operate non-optimally for product verification.

Accordingly, there is a need for product verification systems and methods that optimize the performance of barcode scanning devices for product verification functions relative to conventional devices.

### SUMMARY

Generally speaking, the product verification systems herein utilize multiple imaging sensors to capture image data of objects at multiple stages in a checkout process. In particular, a first imaging sensor may capture image data of objects as they are being unloaded (e.g., prior to scanning), and the second imaging sensor may capture image data of the objects when the objects are scanned and/or when the objects are loaded into a bag after successful scanning. The product verification systems may generally check to ensure that the unloaded objects match the objects that are scanned and/or loaded into a bag, and if there is a disparity between the unloaded objects and the scanned/loaded objects, the systems may generate a corresponding alert.

Accordingly, in an embodiment, the present invention is a multi-stage, product verification imaging system comprising: a first imaging device having a first field of view (FOV) and a housing positioned to direct the first FOV at an unloading plane of a checkout location, a second imaging device having a second FOV and a housing positioned to direct the second FOV to include a loading plane of a bagging area of the checkout location; and one or more processors. The one or more processors may be configured to: capture first image data from the first imaging device and over the first FOV extending over the unloading plane; identify within the first image data from the unloading plane one or more unloaded objects successfully unloaded from the unloading plane; capture second image data from the second imaging device and over the second FOV extending over the loading plane; identify within the second image data one or more objects entering the loading plane; from at least the second image data, identify one or more identifying characteristics of each of the one or more objects entering the loading plane; obtain identification data for the one or more unloaded objects from the unloading plane; compare the identification data for the one or more unloaded objects to the one or more identifying characteristics of each of the one or more objects entering the loading plane; from the comparison, determine if each of the one or more unloaded objects has entered the loading plane of the bagging area; and generate an alert signal for any of the one or more unloaded objects that have not entered the loading plane of the bagging area during a time window.

In a variation of this embodiment, the housing of the second imaging device is positioned to direct the second FOV to include as the loading plane an opening in a bag positioned in the bagging area. Further in this variation, the housing of the second imaging device may be positioned to direct the second FOV such that a bottom edge of the second FOV includes an opening threshold of a bag in the bagging area, or to include at least one of: (i) an entirety of the opening in the bag positioned in the bagging area, (ii) a bottom of a bag in the bagging area, or (iii) the loading plane and a scanning region of the checkout location. Still further in this variation, the second imaging device includes a two-dimensional (2D) imaging camera for capturing 2D images as the second image data. Still further in this variation, the second imaging device further includes (i) a three-dimensional (3D) imaging camera for capturing 3D point cloud images as a portion of the second image data that is used to identify the unloading plane within the second FOV, or (ii) a ranging time-of-flight (ToF) imager.

In another variation of this embodiment, the multi-stage, product verification imaging system further comprises a radio frequency identification (RFID) transceiver configured to collect RFID data, wherein the processor is further configured to identify the one or more identifying characteristics of each object from the image data and from the RFID data.

In still another variation of this embodiment, wherein to obtain the identification data for the one or more unloaded objects successfully unloaded from the unloading plane, the processor is configured to: identify, in the first image data over the first FOV, an indicia associated with an object unloaded from the unloading plane; attempt to decode the indicia; and in response to successfully decoding the indicia, determine the object unloaded from the unloading plane is successfully unloaded, and generate the identification data for the object.

In yet another variation of this embodiment, the processor is further configured to receive, from a scanning device having an imaging sensor with a third FOV directed at a scanning region of the checkout location and separate from the first imaging device and from the second imaging device, the identification data for the one or more unloaded objects scanned at the scanning region. Further in this variation, the scanning region may substantially overlap with the loading plane.

In still another variation of this embodiment, the processor is configured to identify the one or more identifying characteristics of each of the one or more objects entering the loading plane using (i) an object recognition process or (ii) a trained machine learning (ML) model.

In still another variation of this embodiment, the multi-stage, product verification imaging system further comprises: a first weigh scale positioned in an unloading area coinciding with the unloading plane of the checkout location; a second weigh scale positioned in the bagging area of the checkout location, wherein the one or more processors are configured to: detect placement of a container in the unloading area; determine, using the first weigh scale, a total reduction in weight of the container during a weighing window of time; determine, using the second weigh scale, a total increase in weight associated with the one or more objects entering the loading plane of the bagging area; compare the total reduction in weight determined from the first weigh scale to the total increase in weight determined from the second weigh scale; and generate a successful weight transfer signal in response to the total increase in weight being within an acceptable range of the total reduction in weight, and generate an unsuccessful weight transfer signal in response to the total increase in weight being outside the acceptable range of the total reduction in weight.

In yet another variation of this embodiment, the unloading plane may be disposed proximate to at least one of: (i) a top of a shopping basket, (ii) a top of a reusable bag, or (iii) a top of a shopping cart.

In still another variation of this embodiment, the one or more processors are further configured to: capture third image data from the second imaging device and over the second FOV extending over the loading plane; identify within the second image data no objects entering the loading plane; from at least the third image data, identify one or more second identifying characteristics of each of the one or more objects that entered the loading plane; and compare the one or more second identifying characteristics to the one or more identifying characteristics to verify each of the one or more objects are successfully loaded.

In another embodiment, the present invention is a tangible machine-readable medium comprising instructions for product verification that, when executed, cause a machine to at least: capture first image data from a first imaging device having a first FOV including an unloading plane of a checkout location, the first imaging device including a first 2D imaging camera for capturing 2D images as the first image data; identify within the first image data from the unloading plane one or more unloaded objects successfully unloaded from the unloading plane; capture second image data from a second imaging device having a second FOV including a loading plane of a bagging area of the checkout location, the second imaging device including a second 2D imaging camera for capturing 2D images as the second image data; identify within the second image data one or more objects entering the loading plane; from at least the second image data, identify one or more identifying characteristics of each of the one or more objects entering the loading plane; obtain identification data for the one or more unloaded objects from the unloading plane; compare the identification data for the one or more unloaded objects to the one or more identifying characteristics of each of the one or more objects entering the loading plane; from the comparison, determine if each of the one or more unloaded objects has entered the loading plane of the bagging area; and generate an alert signal for any of the one or more unloaded objects that have not entered the loading plane of the bagging area during a time window.

In a variation of this embodiment, the instructions, when executed, further cause the machine to at least: identify the one or more identifying characteristics of each object from (i) the image data and (ii) RFID data collected by an RFID transceiver.

In another variation of this embodiment, to obtain the identification data for the one or more unloaded objects successfully unloaded from the unloading plane, the instructions, when executed, further cause the machine to at least: identify, in the first image data over the first FOV, an indicia associated with an object unloaded from the unloading plane; attempt to decode the indicia; and in response to successfully decoding the indicia, determine the object unloaded from the unloading plane is successfully unloaded, and generate the identification data for the object.

In yet another variation of this embodiment, the instructions, when executed, further cause the machine to at least: receive, from a scanning device having an imaging sensor with a third FOV directed at a scanning region of the checkout location and separate from the first imaging device and from the second imaging device, the identification data for the one or more unloaded objects scanned at the scanning region.

In still another variation of this embodiment, the instructions, when executed, further cause the machine to at least: identify the one or more identifying characteristics of each of the one or more objects entering the loading plane using (i) an object recognition process or (ii) a trained ML model.

In yet another variation of this embodiment, the instructions, when executed, further cause the machine to at least: detect placement of a container in the unloading area; determine, using a first weigh scale positioned in an unloading area coinciding with the unloading plane of the checkout location, a total reduction in weight of the container during a weighing window of time; determine, using a second weigh scale positioned in the bagging area of the checkout location, a total increase in weight associated with the one or more objects entering the loading plane of the bagging area; compare the total reduction in weight determined from the first weigh scale to the total increase in weight determined from the second weigh scale; and generate a successful weight transfer signal in response to the total increase in weight being within an acceptable range of the total reduction in weight, and generate an unsuccessful weight transfer signal in response to the total increase in weight being outside the acceptable range of the total reduction in weight.

In yet another embodiment, the present invention is a computer-implemented product verification method comprising: capturing first image data from a first imaging device having a first FOV including an unloading plane of a checkout location; identifying within the first image data from the unloading plane one or more unloaded objects successfully unloaded from the unloading plane; capturing second image data from a second imaging device having a second FOV including a loading plane of a bagging area of the checkout location; identifying within the second image data one or more objects entering the loading plane; from at least the second image data, identifying one or more identifying characteristics of each of the one or more objects entering the loading plane; obtaining identification data for the one or more unloaded objects from the unloading plane; comparing the identification data for the one or more unloaded objects to the one or more identifying characteristics of each of the one or more objects entering the loading plane; from the comparison, determining if each of the one or more unloaded objects has entered the loading plane of the bagging area; and generating an alert signal for any of the one or more unloaded objects that have not entered the loading plane of the bagging area during a time window.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A-1D depict various embodiments of a product verification system, in accordance with embodiments described herein.

FIG. 2A is a block diagram of an example logic circuit for implementing example methods and/or operations described herein.

FIG. 2B is an example workflow block diagram for providing product verification, in accordance with embodiments described herein.

FIG. 3 illustrates an example product verification method, in accordance with embodiments described herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

It is an objective of the present disclosure to provide systems and methods capable of assisting with product verification in a wide variety of checkout situations. As a result, retailers, retail personnel, and/or other users receive superior product verification support in checkout aisles and/or throughout the retail environment, without needing to manually verify purchased products.

In particular, the techniques of the present disclosure provide solutions to the problems associated with conventional barcode scanning devices. As an example, the techniques of the present disclosure alleviate these issues associated with conventional barcode scanning devices by introducing a multi-stage, product verification imaging system that includes a first imaging device having a first FOV that includes an unloading plane of a checkout location and a second imaging device having a second FOV that includes a loading plane of a bagging area (also referenced herein as a “loading area”) of the checkout location. These components enable the computing systems described herein to capture first image data from the first imaging device and second image data from the second imaging device, and to identify objects unloaded at an unloading plane and objects entering a loading plane. Based on this information, the components may also enable the computing systems to determine if each of the unloaded objects has entered the loading plane of the bagging area; and if not, to generate an alert signal for any of the unloaded objects that have not entered the loading plane of the bagging area during a time window. In this manner, the techniques of the present disclosure enable efficient, accurate product verification support without requiring additional oversight, such as from a retail employee.

Accordingly, the present disclosure includes improvements in computer functionality relating to product verification by describing techniques for enhancing security and efficiency of product verification. That is, the present disclosure describes improvements in the functioning of a product verification system itself and results in improvements to technologies in the field of product verification because the disclosed multi-stage, product verification imaging system includes improvements to product verification algorithms. The present disclosure improves the state of the art at least because previous product verification systems lacked enhancements described in this present disclosure, including without limitation, enhancements relating to: (a) object image data capture, (b) object weight capture, (c) object identification functionality, as well as other enhancements relating to product verification described throughout the present disclosure.

In addition, the present disclosure includes applying various features and functionality, as described herein, with, or by use of, a particular machine, e.g., a first imaging device, a second imaging device, a first weigh scale, a second weigh scale, a radio frequency identification (RFID) transceiver, and/or other components as described herein.

Moreover, the present disclosure includes specific features other than what is well-understood, routine, conventional activity in the field, or adding unconventional steps that demonstrate, in various embodiments, particular useful applications, e.g., capturing first image data from the first imaging device and over the first FOV extending over the unloading plane; identifying within the first image data from the unloading plane one or more unloaded objects successfully unloaded from the unloading plane; capturing second image data from the second imaging device and over the second FOV extending over the loading plane; identifying within the second image data one or more objects entering the loading plane; from at least the second image data, identifying one or more identifying characteristics of each of the one or more objects entering the loading plane; obtaining identification data for the one or more unloaded objects from the unloading plane; comparing the identification data for the one or more unloaded objects to the one or more identifying characteristics of each of the one or more objects entering the loading plane; from the comparison, determining if each of the one or more unloaded objects has entered the loading plane of the bagging area; and generating an alert signal for any of the one or more unloaded objects that have not entered the loading plane of the bagging area during a time window.

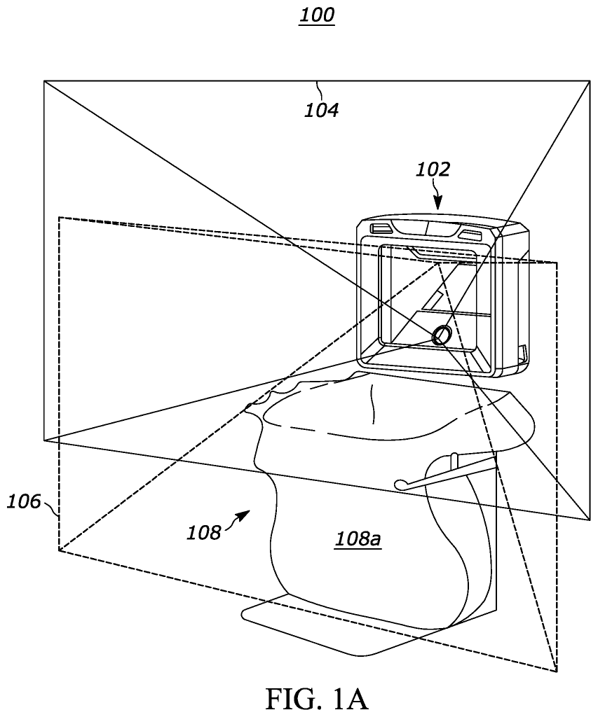

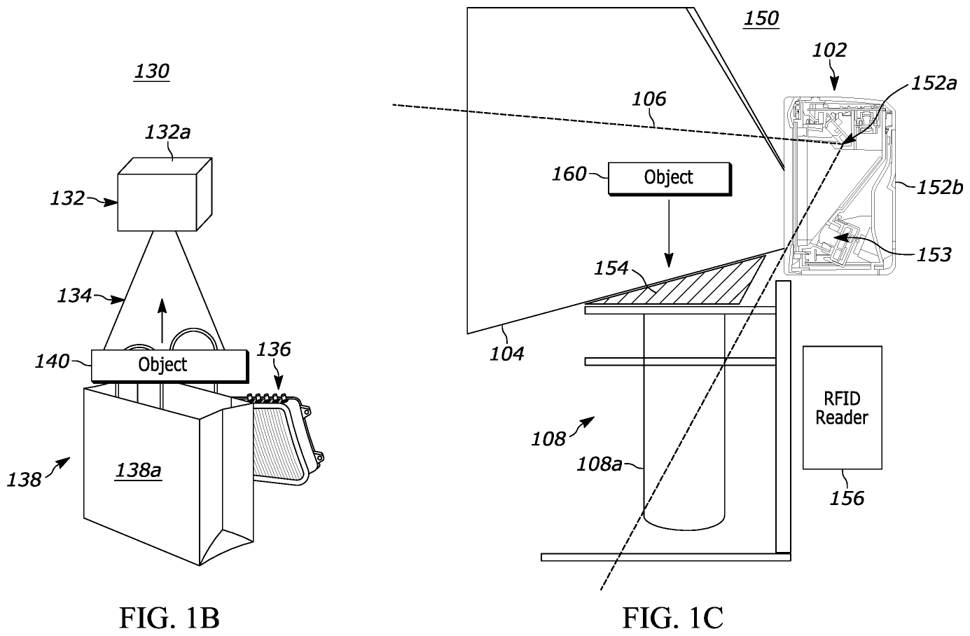

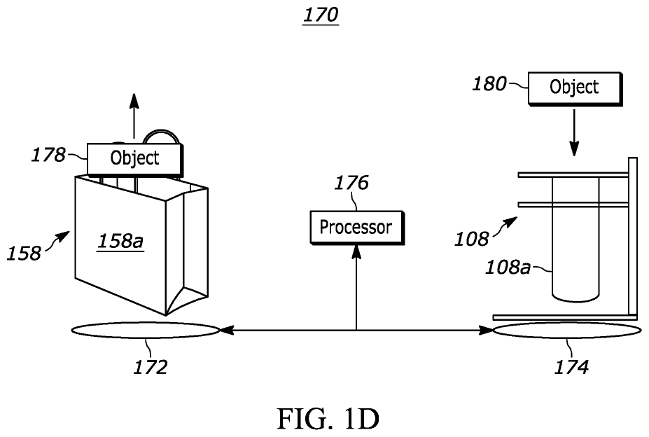

FIGS. 1A-1D depict various embodiments of a product verification system, in accordance with embodiments described herein. It should be appreciated that the various embodiments of the product verification systems 100, 130, 150, 170 described herein are for the purposes of discussion only. Each of the product verification systems 100, 130, 150, 170 may describe only a portion of the entire product verification system implemented in a particular retail location, and such entire product verification system may include some/all of the individual product verification systems 100, 130, 150, 170 working in tandem to verify products. For example, the first product verification system 100 may be combined with the second product verification system 130 to simultaneously monitor a bagging area 108 and an unloading area 138, and thereby provide robust product verification based on a comparison of objects (e.g., object 140) removed from a bag (e.g., bag 138a) in an unloading area (e.g., unloading area 138) and objects (e.g., object 160) placed into a bag (e.g., bag 108a) in the bagging area (e.g., bagging area 108). Moreover, portions of the individual product verification systems 100, 130, 150, 170 may be combined with any other portions of the other individual product verification systems 100, 130, 150, 170.

Generally speaking, FIG. 1A depicts a first product verification system 100 disposed in a checkout location (also referenced herein as a “POS station”). The first product verification system 100 may include a scanning device 102 having a vision camera (not shown) with a vision camera FOV 104 and a scanner (not shown) with a scanning FOV 106. The scanning device 102 may be disposed above a bagging area 108 that includes one or more bags 108a. In this manner, the scanning device 102 may monitor the area above and/or otherwise proximate to the bagging area 108 to perform product verification on products that are placed into the bags 108a. More specifically, the scanning device 102 may verify that products loaded into the bags 108a of the bagging area 108 have been scanned prior to loading.

As described herein, the scanning device 102 may specifically capture image data of objects within the scanning FOV 106 when the object enters a loading plane. The loading plane may generally correspond to an area above and/or otherwise proximate to the top of the bags 108a, such that the scanning device 102 or other suitable processor may identify an object entering a bag 108a as a result of the object entering the loading plane. For example, as objects enter the vision camera FOV 104 and/or the scanning FOV 106, the scanning device 102 may capture image data of the objects. Using the image data, the scanning device 102 may identify the objects entering the loading plane, and may further identify one or more identifying characteristics of each of the objects entering the loading plane. Of course, identifying the objects and/or their identifying characteristics may be performed by the scanning device 102, a POS server (not shown), a remote server (not shown), and/or any other suitable processing device communicatively coupled with the scanning device 102.

In certain instances, the first product verification system 100 may communicate with and/or otherwise capture data that is compared with data from a portion of a product verification system that is configured to monitor an unloading area of a checkout location. For example, FIG. 1B depicts a second product verification system 130 with a scanning device 132 that is positioned above an unloading area 138 of a checkout location. In particular, the scanning device 132 may be or include a vision camera that has an FOV 134 directed to include an unloading plane of the unloading area 138. Generally, the unloading plane may correspond to an area above and/or otherwise proximate to the top of the bags 138a located in the unloading area 138. In this manner, the scanning device 132 may monitor the interior of the bags 138a in the unloading area 138 to determine when objects 140 are unloaded from the bag 138a. For example, in certain embodiments, the unloading plane may be disposed proximate to at least one of: (i) a top of a shopping basket, (ii) a top of a reusable bag (e.g., bag 138a), and/or (iii) a top of a shopping cart.

As mentioned, the scanning device 132 may be positioned above the bag 138a and looking down into the bag 138a, such that the FOV 134 includes the interior of the bag 138a. The scanning device 132 may also include a scanner (not shown) that is configured to detect and decode barcodes and/or other object 140 indicia. Indeed in some examples, the scanning device 132 (and/or the scanning device 102) may be implemented with a dedicated indicia scanning system such as a POS system to coordinate detection and decode of barcodes of items scanned for purchase at a POS bioptic or other scanner, with items removed from an unloading area and placed into a bagging area as detected by the scanning devices 132 and 102, respectively. In any event, this scanner (not shown) may also be oriented downwards, such that the corresponding FOV includes the interior of the bag 138a. This configuration of the scanning device 132 may be more intuitive for a user than conventional systems because the user may simply rotate the object 140 so that the barcode faces the user in order to achieve a decode. Further, the second product verification system 130 may avoid dust and/or other particular matter accumulating on the transmissive window or lenses of scanning device 132 as a result of the downward facing orientation. As a result, the second product verification system 130 may reduce the needing for the transmissive window and/or lenses of the scanning device 132 to be cleaned by an employee.

In certain embodiments, the scanning device 132 may be or include a separate vision camera that is oriented in the same or approximately the same/similar direction as an indicia scanner/decoder. Moreover, the scanning device 132 may be or include a single imager that is configured to perform both barcode/indicia scanning and vision applications (e.g., object recognition). In these embodiments, the scanning device 132 (or multiple scanning devices 132) may be located in the unloading area 138 and/or the bagging area 108. The vision camera may be configured to see directly into the bag 138a to make sure every object 140 placed inside was scanned, and/or the vision camera may view into the reusable shopping bag 138a to ensure a customer removes every object 140 from the bag 138a and scans every object 140. In these embodiments, the scanning device 132 may be located in a position relative to the bagging area 138 and/or the unloading area 138 that ensures the scanning device 132 may have adequate resolution for object recognition while avoiding being easily bumped and/or otherwise interfered with by users. For example, the scanning device 132 may be located in a position above the bag 138a, 108a and toward a back edge of the bag 138a, 108a relative to the forward position of the customer or other user that is loading/unloading the bag 138a, 108a.

In some embodiments, the scanning device 132 may be or include a vision camera positioned to monitor a location for customers to place reusable bags 138a for unloading/loading and another vision camera positioned to monitor a location for disposable bags (e.g., bagging area 108). The location for disposable bags may also double as a location for reusable bags 138a to be placed and monitored. Further in these embodiments, the second product verification system 130 may provide instructions to a user regarding where to place a reusable bag 138a if such a reusable bag 138a is identified within the vision camera FOV (e.g., FOV 134). In this manner, the second product verification system 130 may ensure that the customer places their reusable bag(s) 138a in position to be properly inspected by the scanning device 132.

As mentioned, the scanning device 132 may be configured to analyze the interior of a bag (e.g., bags 138a, 108a) to ensure every object 140, 160 contained therein has been scanned. As part of this analysis, the scanning device 132 may be further configured to analyze the configuration of a bag 138a, 108a to determine/recognize whether the scanning device 132 is viewing a top flap of a bag 138a, 108a or a bottom of the bag 138a, 108a. In response to determining that the scanning device 132 is viewing a top flap (or other exterior portion) of a bag 138a, 108a, and regardless of whether the device 132 is positioned at an unloading area and/or a loading area, the device 132 may be further configured to issue an instruction to the user. More specifically, the scanning device 132 may instruct the user to pull back the top flap or otherwise reposition the bag 138a, 108a so that the entire interior of the bag 138a, 108a may be imaged to the bottom of the bag 138a, 108a, thereby ensuring every object 140, 160 has been removed and scanned.

Additionally, the second product verification system 130 may include an RFID reader 136 oriented towards the bag 138a to detect objects within the bag 138a. The RFID reader 136 may help ensure that every object 140 contained within the bag 138a is removed during the unloading process, and may be compared with data from the first product verification system 100 to determine differences between objects 140 that were removed from a customer's bag 138a and objects 160 that are loaded into a bag 108a in the bagging area 108. The RFID reader 136 may scan through the objects 140 of the bag 138a to detect items that may be hidden or unseen. Certain high value, high risk, and/or other items may include an RFID tag that the RFID reader 136 may detect while the items are within the bag 138a. The RIFD reader 136 may transmit this RFID data to the scanning device 132, 102 and/or to any other suitable processor to detect if items in the bag 138a have not been scanned. For example, the RFID reader 136 may detect RFID tags on an object 10 disposed within the bag 138a, and this data may be utilized to detect when the object 140 does not appear within a bag 108a within the bagging area 108. In this circumstance, the scanning devices 132, 102, and/or other suitable processing device(s) may generate an alert indicating a failed product verification and/or an otherwise non-verified product.

FIG. 1C depicts a third product verification system 150 that includes the scanning device 102 that is positioned over the bagging area 108 of the checkout location. As previously mentioned, the scanning device 102 may include a vision camera 153 with the FOV 104 and a scanner 152a with the FOV 106, such that the vision camera 153 and/or the scanner 152a may be directed to include the loading plane of the bagging area 108. The third product verification system 150 also includes an RIFD reader 156 disposed proximate to the bags 108a in the bagging area 108, and an object 160 being placed into a bag 108a.

Generally speaking, the image data captured by the vision camera 153 may be utilized to perform object recognition on the object(s) 160 within the FOV 104, and the image data captured by the scanner 152a may be processed to decode indicia associated with the object(s) 160 within the FOV 106. Regardless, the vision camera 153 and the scanner 152a (and/or any other vision cameras (132) and/or scanners disclosed herein) may be imaging devices that include 2D/3D imaging capabilities, such that the vision camera 153 and the scanner 152a may be configured to capture image data including the loading plane of the bagging area 108. For example, in certain embodiments, the vision camera 153 and/or the scanner 152a may include (i) a 2D imaging camera for capturing 2D images, (ii) a 3D imaging camera for capturing 3D point cloud images that are used to identify the loading plane within the FOV 104, 106, and/or (iii) a ranging ToF imager.

In embodiments where the vision camera 153 and/or the scanner 152a includes a 3D imaging camera or ranging ToF imager, the vision camera 153 and/or the scanner 152a may capture 3D image data that includes depth information. Thus, the scanning device 102 and/or other suitable processor may process the 3D image data to determine depth values corresponding to objects 160 located within the FOV 104, 106. In these embodiments, the loading plane may be defined by a combination of a vertical position of the object 160 within the FOV 104, 106 and a depth value of the object 160 within the FOV 104, 106. To illustrate, the object 160 may appear within 3D image data captured by the vision camera 153, and the scanning device 102 may determine that the object 160 is near a bottom edge of the FOV 104 (e.g., near to the top of the bags 108a) and is disposed at a substantially similar depth value as the bags 108a. The scanning device 102 may thereby determine that the object 160 has entered the loading plane because the vertical position and depth value of the object 160 indicates that the object 160 is likely being placed within a bag 108a in the bagging area 108.

Additionally, or alternatively, the loading plane may be or include a portion 154 of the FOV 106 that is generally or substantially above the tops of bags 108a in the bagging area 108. The portion 154 of the FOV 106 may not be visible by the vision camera 153, as the portion 154 may be below the bottom edge of the FOV 104. The portion 154 may also represent a region of the FOV 106 that is unobstructed by the bags 108a or other portions of the bagging area 108 because the portion 154 is in front of the bags 108a or other portions of the bagging area 108. Thus, the portion 154 of the FOV 106 may generally represent an area that is substantially proximate to the tops of bags 108a within the bagging area 108. Accordingly, object(s) 160 appearing in image data within the portion 154 of the FOV 106 may be presumed as being loaded into a bag 108a because the object(s) 160 are also substantially proximate to the tops of the bags 108a. In this manner, the scanning device 102 may determine that the object(s) 160 has entered the loading plane even in the circumstance where the scanner 152a is only configured to capture 2D image data of objects 160 within the FOV 106.

More generally, the scanning devices 102, 132 may include any suitable number of 2D and/or 3D cameras that may have FOVs that may substantially correspond to the FOVs of any scanners that are also included in the scanning devices 102, 132. For example, as illustrated in FIG. 1C, the scanner 152a may include a scanner (e.g., a 2D camera) that is configured to detect and decode indicia (e.g., barcodes, QR codes, etc.) that has the FOV 106. The scanner 152a may also include a 3D camera that has a FOV that substantially corresponds to the FOV 106, such that the scanner 152a may capture 3D image data with a plurality of point cloud data. This point cloud data can help to identify when an object (e.g., object 140, 160) has passed a plane relative to the scanning devices 102, 132 based on a predetermined plane that may be defined by depth and lateral coordinates corresponding to the point cloud data. By identifying an object 140, 160 passing through the predetermined plane, the scanning devices 102, 132 and/or other suitable processing device(s) may determine when the object 140, 160 is entering an unloading/loading plane.

In any event, the scanning device 102 and/or any other suitable processing device may also include an application (e.g., object identification module 206a) to track which objects 140 entered a bag 138a without being scanned. However, it should be understood that the application (e.g., object identification module 206a) may be stored/executed on an independent POS server (not shown), a remote server (not shown), and/or any other suitable processing device that is communicatively coupled with the scanning device 102 to receive the image data, decoded indicia, and/or any other data from the scanning device 102. Objects 160 that enter a bag 108a without the scanning device 102 scanning and/or otherwise capturing an associated code (e.g., universal product code (UPC)) of the object 160 may be flagged by the scanning device 102 for one of a number of product verification mitigations.

In certain embodiments, the vison camera 153 may be positioned so that the FOV 104 overlaps with the FOV 106. In these embodiments, the vision camera 153 and a scanner 152a of the scanning device 102 may collectively perform product verification. In particular, the vision camera 153 may capture image data of an object 160 that is entering the bagging area 108, and the scanning device 102 or other suitable processors may determine an identity of the object 160 based on the image data. The scanning device 102 may then compare this identity of the object 160 to a listing of objects that have been scanned by the scanner 152a. If the object 160 does not appear in the listing of objects scanned by the scanner 152a, then the scanning device 102 may determine that the object 160 has been bagged without being scanned (e.g., a non-verified product), and may generate an alert. These embodiments may also advantageously reduce the actions and/or movements a customer must take at the checkout location because the object 160 being scanned by the scanning device 102 is already in an optimal position to be placed directly into a bag 108a in the bagging area 108.

Additionally, or alternatively, the scanning device 102 may be used as a vision hub where one camera (e.g., vison camera 153) has an FOV oriented forward to view the customer and overlap the FOV 104, and another camera (not shown) can be positioned remotely to monitor the top of the bag 108a and/or have a FOV oriented downward to view/monitor the bottom of the bag 108a. Connecting the FOVs of these vision cameras with the scanner 152a may enable synchronization with the illumination system and analysis of visual image data with information received from successful decodes of object 160 indicia. Further, the scanning device 102 and/or other suitable processor may perform image recognition on the captured image data in addition to processing/decoding the indicia (e.g., decoding the object 160 barcode for example as part of a point-of-sale transaction or other scanning event).

As part of ensuring that a customer has scanned/paid for every item in their cart, bag, etc. the third product verification system 150 may also include an RFID reader 156 disposed proximate to the bagging area 108. The RFID reader 156 may scan through the objects 160 of the bag 108a to detect items that may be hidden or unseen. Certain high value, high risk, and/or other items may include an RFID tag (or other RFID transceiver) that the RFID reader 156 may detect while the items are within the bag 10a8. The RFID reader 156 may transmit this RFID data to the scanning device 102 and/or to any other suitable processor to detect if items in the bag 10a8 have not been scanned. For example, the RFID reader 156 may detect RFID tags on items disposed within disposable bags (e.g., bag 108a) to identify non-verified products (e.g., scan avoidance or ticket switching events); and may be particularly advantageous to detect/identify items hidden within a reusable bag (e.g., bag 108a) that is not transparent or translucent, such that store employees or others may be completely unable to view the contents of the reusable bag from a side perspective.

In certain embodiments, the product verification systems 100, 130, 150 may also include weigh scales that provide additional data regarding the objects (e.g., objects 140, 160) removed from a customer's bags, carts, etc. in an unloading area (e.g., unloading area 138) and subsequently placed in bags in a bagging area (e.g., bagging area 108). For example, FIG. 1D. illustrates a fourth product verification system 170 that includes a first weigh scale 172 and a second weigh scale 174 disposed proximate to the unloading area 138 and the bagging area 108, respectively. The first weigh scale 172 may be positioned in the unloading area 138, and as such, may coincide with the unloading plane monitored by the scanning device 132 at the checkout location. The second weigh scale 174 may be positioned in the bagging area 108 of the checkout location, and as such, may coincide with the loading plane monitored by the scanning device 102 at the checkout location. These scales 172, 174 may be communicatively coupled to a processor 176 that may receive weigh data from the scales 172, 174 to make various determinations, as described herein. The processor 176 may generally be part of any suitable device, such as the scanning devices 132, 102, remote servers (not shown), and/or any other device(s) communicatively connected to the product verification systems 100, 130, 150, 170.

Generally speaking, the first weigh scale 172 may weigh the bag 138a to ensure every object 178 is removed from the bag 138a for scanning. Moreover, the processor 176 may receive the total weight of the bag 138a prior to the customer removing any objects 178, and may iteratively receive weights of the bag 138a as objects 178 are removed from the bag 138a. The processor 176 may iteratively receive this weight data of the bag 138a as objects 178 are sequentially removed, and may calculate an expected weight of the objects to be weighed by the second weigh scale 174 based on the objects 180 scanned at the bagging area 108. The processor 176 may then compare the weights received from the second weigh scale as the bag 108a is sequentially loaded with objects 180 against the initial expected weights calculated based on the weight data received from the first weigh scale 172.

Additionally, the fourth product verification system 170 may function as another level of product verification that may be coupled with and/or exist independently of the first, second, and/or third product verification systems 100, 130, 150. As an example, when the weight detected by the second weigh scale 174 increases more dramatically than expected based on the scanned object 180, the processor 176 may determine a failed product verification and/or an otherwise non-verified product as a result of ticket switching. In this manner, the fourth product verification system 170 may enable accurate, efficient detection of a failed product verification and/or an otherwise non-verified product without requiring vision camera capabilities.

More specifically, the processor 176 may be configured to detect placement of a container (e.g., bag 138a) in the unloading area 138. The processor 176 may then receive data from the first weigh scale 172 to determine a total reduction in weight of the container 138a during a weighing window of time. In other words, the processor 176 may receive data from the first weigh scale 172 while the customer/user is removing objects 178 from the container 138a, such that the weighing window of time may correspond to the period of time from when the first weigh scale 172 first detects a non-zero weight until the scale 172 detects an approximately zero weight.

The processor 176 may then receive data from the second weigh scale 174 to determine a total increase in weight associated with the one or more objects 180 entering the loading plane of the bagging area 108. The processor 176 may then compare the total reduction in weight determined from the data received from the first weigh scale 172 to the total increase in weight determined from the data received from the second weigh scale 174. Thereafter, the processor 176 may generate a successful weight transfer signal in response to the total increase in weight being within an acceptable range of the total reduction in weight, and may generate an unsuccessful weight transfer signal in response to the total increase in weight being outside the acceptable range of the total reduction in weight. In some embodiments, the acceptable range may be +/−5% and/or any other suitable value or combinations thereof.

More generally, the components of the product verification systems 100, 130, 150, 170 may be or include various additional components/devices. For example, the scanning devices 132, 102 may include a housing 132a, 152b that include the various imaging devices (e.g., vision camera 153, scanner 152a). The housing 132a, 152b may be positioned to direct the FOVs 104, 106, 134 of the various imaging devices in particular directions to capture image data, as described herein. Namely, the housing 152b of the scanning device 102 may be positioned to direct the FOVs 104, 106 to include the loading plane of the bagging area 108 of the checkout location. The housing 132a of the scanning device 132 may be positioned to direct the FOV 134 at the unloading plane of the checkout location.

Of course, while the example product verification systems 100, 130, 150, 170 of FIGS. 1A-1D may be described as pertaining to a retail environment, more generally the systems 100, 130, 150, 170 may be deployed in any of a variety of environments including a warehouse facility, a distribution center, etc.

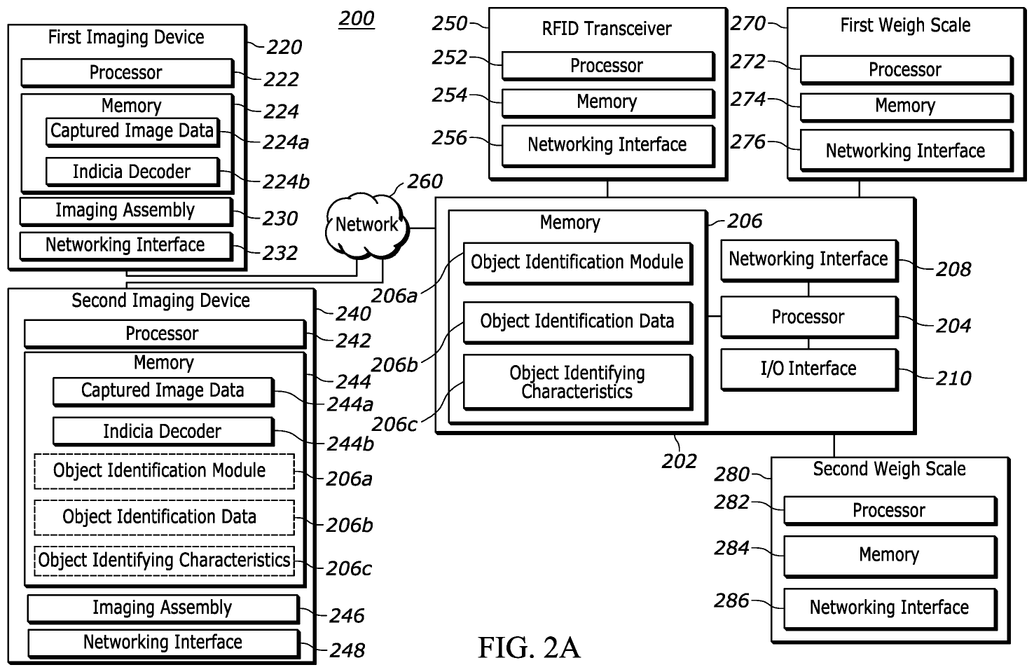

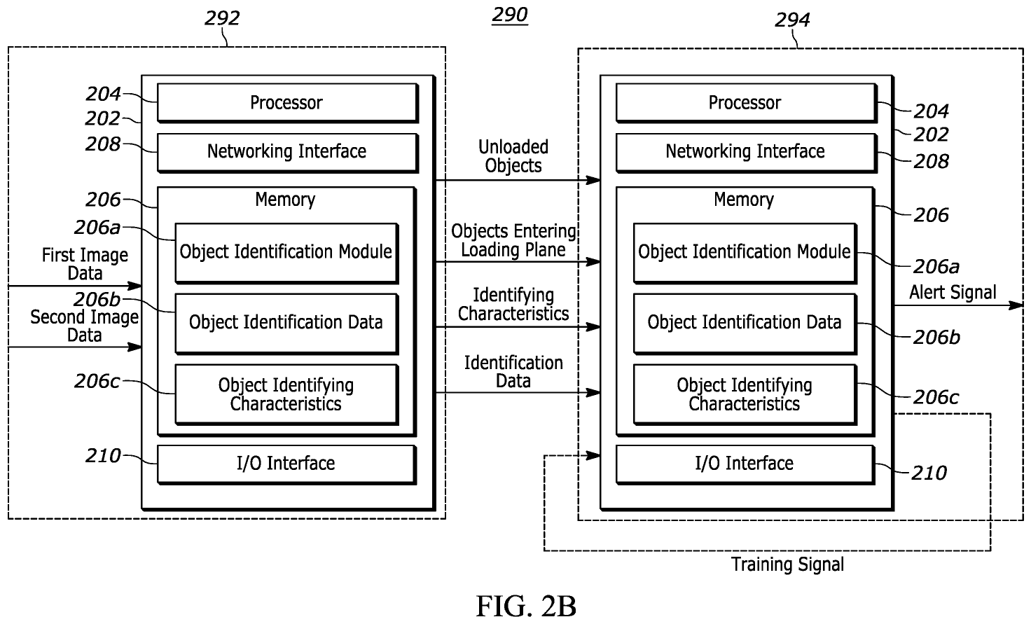

FIG. 2A is a block diagram of an example logic circuit 200 for implementing example methods and/or operations described herein. The example logic circuit 200 of FIG. 2A includes a processing platform 202 capable of executing instructions to, for example, implement operations of the example methods described herein, as may be represented by the flowcharts of the drawings that accompany this description. Other example logic circuits capable of, for example, implementing operations of the example methods described herein include field programmable gate arrays (FPGAs) and application specific integrated circuits (ASICs).

The example processing platform 202 of FIG. 2A includes a processor 204 such as, for example, one or more microprocessors, controllers, and/or any suitable type of processor. The example processing platform 202 of FIG. 2A includes memory (e.g., volatile memory, non-volatile memory) 206 accessible by the processor 204 (e.g., via a memory controller). The example processor 204 interacts with the memory 206 to obtain, for example, machine-readable instructions stored in the memory 206 corresponding to, for example, the operations represented by the flowcharts of this disclosure. The example processor 204 may also interact with the memory 206 to obtain, or store, instructions related to the first imaging device 220, the second imaging device 240, the RFID transceiver 250, the first weigh scale 270, and/or the second weigh scale 280. Additionally, or alternatively, machine-readable instructions corresponding to the example operations described herein may be stored on one or more removable media (e.g., a compact disc, a digital versatile disc, removable flash memory, etc.) that may be coupled to the processing platform 202 to provide access to the machine-readable instructions stored thereon.

However, in certain embodiments, the example processing platform 202 of FIG. 2A may be part of and/or otherwise included in any of the components illustrated in FIG. 2A. For example, the example processing platform 202 may be included in the second imaging device 240. In this example, each of the object identification module 206a, the object identification data 206b, and the object identifying characteristics 206c may be stored in the memory 244 of the second imaging device 240. The second imaging device 240 may then utilize the processor 242, the memory 244, the imaging assembly 246, and/or the networking interface 248 to implement the functionality described herein with respect to each of the modules (e.g., object identification module 206a) and/or data (e.g., object identification data 206b, object identifying characteristics 206c) stored in memory 244.

The example processing platform 202 of FIG. 2A also includes a network interface 208 to enable communication with other machines via, for example, one or more networks. The example network interface 208 includes any suitable type of communication interface(s) (e.g., wired and/or wireless interfaces) configured to operate in accordance with any suitable protocol(s). For example, in some embodiments, the networking interface 208 may transmit data or information (e.g., imaging data, illumination pulse emission signals, etc., described herein) between remote processor(s) and/or a remote server (e.g., processors 222, 242, 252, 272, 282), and the processing platform 202.

The example, processing platform 202 of FIG. 2A also includes input/output (I/O) interfaces 210 to enable receipt of user input and communication of output data to the user.

As illustrated in FIG. 2A, the first imaging device 220 includes a processor 222, a memory 224, an imaging assembly 230, and a networking interface 232. The memory 224 may include captured image data 224a and an indicia decoder 224b. Similarly, the second imaging device 240 include a processor 242, a memory 244, an imaging assembly 246, and a networking interface 248. The memory 244 may include captured image data 244a, an indicia decoder 244b, the object identification module 206a, the object identification data 206b, and the object identifying characteristics 206c.

Generally, the imaging devices 230, 240 may include one or more imaging sensor(s) as part of the imaging assemblies 230, 246. In particular, each of the first imaging device 220 and/or the second imaging device 240 may include one or more sensors configured to capture image data corresponding to a target object (e.g., object 140, 160, 178, 180), an indicia associated with the target object, and/or any other suitable image data. The imaging devices 220, 240 may be any suitable type of imaging device, such as a bioptic barcode scanner, a slot scanner, a vision camera, an original equipment manufacturer (OEM) scanner inside of a kiosk, a handle/handheld scanner, and/or any other suitable imaging device type.

As an example, the second imaging device 240 may be or include a barcode scanner with one or more barcode imaging sensors that are configured to capture image data representative of an environment appearing within an FOV (e.g., scanning FOV 135) of the second imaging device 240, such as one or more images of an indicia associated with a target object (e.g., object 140). The second imaging apparatus 240 may also be or include a vision camera with one or more visual imaging sensors that are configured to capture image data representative of an environment appearing within a FOV (e.g., first FOV 134) of the second imaging device 240, such as one or more images of the target object 140.

The first imaging device 220 and/or the second imaging device 240 may also include an illumination source (not shown) that is generally configured to emit illumination during a predetermined period corresponding to image data capture of the imaging assemblies 230, 246. In some embodiments, the first imaging device 220 and/or the second imaging device 240 may use and/or include color sensors and the illumination source may emit white light illumination. Additionally, or alternatively, the first imaging device 220 and/or the second imaging device 240 may use and/or include a monochrome sensor configured to capture image data of an indicia associated with the target object in a particular wavelength or wavelength range (e.g., 600 nanometers (nm)-700 nm).

More specifically, the first imaging device 220 and/or the second imaging device 240 may each include subcomponents, such as one or more imaging sensors and/or one or more imaging shutters (not shown) that are configured to enable the imaging devices 220, 240 to capture image data corresponding to, for example, a target object and/or an indicia associated with the target object. It should be appreciated that the imaging shutters included as part of the imaging devices 220, 240 may be electronic and/or mechanical shutters configured to expose/shield the imaging sensors of the devices 220, 240 from the external environment. In particular, the imaging shutters that may be included as part of the imaging devices 220, 240 may function as electronic shutters that clear photosites of the imaging sensors at a beginning of an exposure period of the respective sensors.

Regardless, such image data may comprise 1-dimensional (1D) and/or 2-dimmensional (2D) images of a target object, including, for example, packages, products, or other target objects that may or may not include barcodes, QR codes, or other such labels for identifying such packages, products, or other target objects, which may be, in some examples, merchandise available at retail/wholesale store, facility, or the like. A processor (e.g., processor 204, 242) of the example logic circuit 200 may thereafter analyze the image data of target objects and/or indicia passing through a FOV (e.g., scanning FOV 135) of the imaging devices 220, 240.

This data may be utilized by the processors 204, 222, 242, 252, 272, 282 to make some/all of the determinations described herein. For example, the object identification module 206a may include executable instructions that cause the processors 204, 222, 242 to perform some/all of the analysis and determinations described herein. This analysis and determination may also include the object identification data 206b and the object identifying characteristics 206c, as well as any other data collected by or from the first imaging device 220, the second imaging device 240, the RFID transceiver 250, the first weigh scale 270, and/or the second weigh scale 280.

Namely, the first imaging device may capture first image data over a first FOV (e.g., FOV 154) of the unloading plane. The object identification module 206a may then cause the processor 204, 222, 242 to analyze this first image data to identify, within the first image data from the unloading plane, one or more unloaded objects (e.g., object 160) successfully unloaded from the unloading plane. The second imaging device 240 may capture second image data over the second FOV (e.g., FOV 134) of the loading plane. The object identification module 206a may then cause the processor 204, 222, 242 to analyze this second image data to identify, within the second image data, one or more objects (e.g., object 140) entering the loading plane. The object identification module 206a may also include instructions that cause the processor 204, 222, 242 to identify, from at least the second image data, one or more identifying characteristics of each of the one or more objects entering the loading plane. The processors 204, 222, 242 may identify the identifying characteristics by matching the characteristics identified in the second image data with the object identifying characteristics 206c stored in memory 206, 244.

Further, the object identification module 206a may include instructions for the processors 204, 222, 242 to obtain identification data 206b for the one or more unloaded objects from the unloading plane. The object identification module 206a may then instruct the processors 204, 222, 242 to compare the object identification data 206b for the one or more unloaded objects to the one or more identifying characteristics of each of the one or more objects entering the loading plane, and from the comparison, determine if each of the one or more unloaded objects has entered the loading plane of the bagging area. The object identification module 206a may then cause the processors 204, 222, 242 to generate an alert signal for any of the one or more unloaded objects that have not entered the loading plane of the bagging area during a time window.

Moreover, as illustrated in FIG. 2A, each of the RFID transceiver 250, the first weigh scale 270, and the second weigh scale 280 may also include memories 254, 274, 284, and networking interfaces 256, 276, 286. As such, each of the RFID transceiver 250, the first weigh scale 270, and the second weigh scale 280 may connect and communicate to the processing platform 202, the first imaging device 220, and/or the second imaging device 240 through the network 260. Each of the first imaging device 220, the second imaging device 240, and/or the processing platform 202 may also receive and/or store RFID tag data, and/or weight data from the RFID transceiver 250, the first weigh scale 270, and/or the second weigh scale 280. The processing platform 202, the first imaging device 220, and/or the second imaging device 240 may store this RFID tag data and/or the weight data along with the captured image data 224a, 244a, the indicia decoder 224b, 244b, the object identification module 206a, the object identification data 206b, and/or the object identifying characteristics 206c.

In particular, all of this data may be used by the processors to determine various outputs. For example, FIG. 2B is an example workflow block diagram 290 for providing product verification, in accordance with embodiments described herein. The example workflow 400 generally illustrates various data received/retrieved by the processing platform 202 that is utilized by the computer-executable instructions (e.g., object identification module 206a) stored in memory 206 as inputs to generate various outputs. At a first time 292, the various data received/retrieved by the processing platform 202 includes first image data and second image data, and the processing platform 202 may output identified unloaded objects, identified objects entering the loading plane, identifying characteristics, and identification data. At a second time 294, the processing platform 202 may receive/retrieve the identified unloaded objects, the identified objects entering the loading plane, the identifying characteristics, the identification data, and/or training signals to output an alert signal and/or the training signal.

Thus, the inputs/outputs of the processing platform 202 at the first time 292 may generally represent the processing platform 202 extracting and/or otherwise determining data from the first image data and the second image data, and the inputs/outputs of the processing platform 202 at the second time 294 may generally represent the processing platform 202 interpreting the outputs from the first time 292 to generate an alert signal and/or training signal. Of course, it should be understood that the input/outputs illustrated in FIG. 2B are for the purposes of discussion only, and may not represent and/or include every input/output.

For example, in certain instances, the processing platform 202 may receive, retrieve, and/or generate the identified unloaded objects, the identified objects entering the loading plane, the identifying characteristics, and/or the identification data. The identified unloaded objects may be or include the number, type, or specific composition of objects that are included in the first image data and/or the second image data. More specifically, the identified unloaded objects may be derived from the first image data that includes objects within the first FOV 134 of the scanning device 132. The identified objects entering the loading plane may be or include the number, type, or specific composition of objects that are included in the first image data and/or the second image data. More specifically, the identified objects entering the loading plane may be derived from the second image data that includes objects within the second FOV 154 of the scanning device 152.

The identifying characteristics may be visual aspects of the objects that are extracted by the processor 204 during object recognition, machine learning (ML) techniques, and/or other analysis performed on the second image data. For example, the identifying characteristics may be and/or include a color of the objects, and approximate size of the objects, a shape of the objects, and/or any other suitable characteristics of the objects included within the second image data. The identification data may be a product name, a product price, a UPC, and/or any other suitable information corresponding to objects included in the first image data. The processing platform 202 may utilize these values and/or other similar values as part of the evaluations performed at the first time 292, the second time 294, training/re-training models via the training signal, and/or at any other suitable time or combinations thereof. However, in certain embodiments, the identifying characteristics may be or include a product name, a product price, a UPC, and/or any other suitable information; and the identification data may be and/or include a color of the objects, and approximate size of the objects, a shape of the objects, and/or any other suitable characteristics.

Using some/all of this data as input, the models that are included as part of the object identification module 206a and/or other instructions stored in memory 206 may instruct the processor 204 to determine one or more of the outputs. For example, at the first time 292, the processors 204 may utilize the first image data and/or the second image data to determine/identify the unloaded objects, the objects entering the loading plane, the identifying characteristics, and/or the identification data. At the second time 294, the processors 204 may utilize the unloaded objects, the objects entering the loading plane, the identifying characteristics, and/or the identification data to determine the alert signal and/or the training signal.

As previously mentioned, the alert signal may generally include an alert message for a store employee or manager corresponding to a failed product verification and/or an otherwise non-verified product identified by the processor 204. For example, the alert message may indicate that any of the one or more unloaded objects may not also be included as one of the objects entering the unloading plane during a time window corresponding to the customer's checkout process. In certain embodiments, the alert signal may also include a confidence interval or value representing the confidence of the estimation/prediction made by the object recognition process, ML algorithm(s), and/or any other suitable algorithms/models included as part of the object identification module 206a.

For example, the confidence interval may be represented in the alert signal by a single numerical value (e.g., 1, 2, 3, etc.), an interval (e.g., 90% confident that between one and two unloaded objects do not appear in the objects entering the loading plane), a percentage (e.g., 95%, 50%, etc.), an alphanumerical character(s) (e.g., A, B, C, etc.), a symbol, and/or any other suitable value or indication of a likelihood that the estimated difference between the unloaded objects and the objects entering the loading plane determined by the object recognition, ML model (e.g., ML model of the object identification module 206a), and/or other suitable algorithms/models is accurate and representative of a genuine failed product verification and/or an otherwise non-verified product.

In certain embodiments, the processing platform 202 may also determine a training signal to train and/or re-train models that are included as part of the object identification module 206a and/or other instructions stored in memory 206. Generally, the training signal may include and/or otherwise represent an indication that an estimation/prediction generated by the models that are included as part of the object identification module 206a was correct, incorrect, accurate, inaccurate, and/or otherwise reflect the ability of the models to generate accurate outputs in response to receiving certain inputs.

In particular, and in some embodiments, the central server 110 may utilize a training signal to train the ML model (e.g., as part of the object identification module 206a), and the training signal may include a plurality of training data. The plurality of training data may include (i) a plurality of training image data, (ii) a plurality of training unloaded object data, (iii) a plurality of training objects entering a loading plane, (iv) a plurality of training identifying characteristics, (v) a plurality of training identification data, and/or any other suitable training data or combinations thereof. As a result of this training and/or re-training performed using the training signal, the trained ML model may then generate identifying characteristics based on (i) the first image data, (ii) the second image data, and/or any other suitable values or combinations thereof. Accordingly, the processing platform 202 may utilize the training signal in a feedback loop that enables the processing platform 202 to re-train, for example, the models that are included as part of the object identification module 206a based, in part, on the outputs of those models during run-time operations and/or during a dedicated offline training session.

Generally, machine learning may involve identifying and recognizing patterns in existing data (such as generating identifying characteristics of objects entering the loading plane) in order to facilitate making predictions or identification for subsequent data (such as using the model on new image data in order to determine identifying characteristics of the objects entering the loading plane). Machine learning model(s), such as the Al based learning models (e.g., included as part of the object identification module 206a) described herein for some aspects, may be created and trained based upon example data (e.g., “training data”) inputs or data (which may be termed “features” and “labels”) in order to make valid and reliable predictions for new inputs, such as testing level or production level data or inputs.

More specifically, the machine learning model that is included as part of the object identification module 206a may be trained using one or more supervised machine learning techniques. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining and/or assigning weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

For example, in certain aspects, the supervised machine learning model may employ a neural network, which may be a convolutional neural network (CNN), a deep learning neural network, or a combined learning module or program that learns in two or more features or feature datasets (e.g., prediction values) in particular areas of interest. The machine learning programs or algorithms may also include natural language processing, semantic analysis, automatic reasoning, support vector machine (SVM) analysis, decision tree analysis, random forest analysis, K-Nearest neighbor analysis, naïve Bayes analysis, clustering, reinforcement learning, and/or other machine learning algorithms and/or techniques. In some aspects, the artificial intelligence and/or machine learning based algorithms may be included as a library or package executed on the processing platform 202. For example, libraries may include the TENSORFLOW based library, the PYTORCH library, and/or the SCIKIT-LEARN Python library.

The supervised machine learning model may be configured to receive image data as input (e.g., second image data) and output identifying characteristics as a result of the training performed using the plurality of training image data, plurality of training identifying characteristics, and the corresponding ground truth identifying characteristics. The output of the supervised machine learning model during the training process may be compared with the corresponding ground truth identifying characteristics. In this manner, the object identification module 206a may accurately and consistently generate identifying characteristics that identify the objects entering the loading plane because the differences between the training identifying characteristics and the corresponding ground truth identifying characteristics may be used to modify/adjust and/or otherwise inform the weights/values of the supervised machine learning model (e.g., an error/cost function).

As previously mentioned, machine learning may generally involve identifying and recognizing patterns in existing data (such as generating training identifying characteristics identifying objects entering the loading plane based on training image data) in order to facilitate making predictions or identification for subsequent data (such as using the model on new image data indicative of objects entering the loading plane to determine or generate identifying characteristics of the objects).

Additionally, or alternatively, in certain aspects, the machine learning model included as part of the object identification module 206a, may be trained using one or more unsupervised machine learning techniques. In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

It should be understood that the unsupervised machine learning model included as part of the object identification module 206a may be comprised of any suitable unsupervised machine learning model, such as a neural network, which may be a deep belief network, Hebbian learning, or the like, as well as method of moments, principal component analysis, independent component analysis, isolation forest, any suitable clustering model, and/or any suitable combination thereof.

It should be understood that, while described herein as being trained using a supervised/unsupervised learning technique, in certain aspects, the Al based learning models described herein may be trained using multiple supervised/unsupervised machine learning techniques. Moreover, it should be appreciated that the identifying characteristic generations may be performed by a supervised/unsupervised machine learning model and/or any other suitable type of machine learning model or combinations thereof.

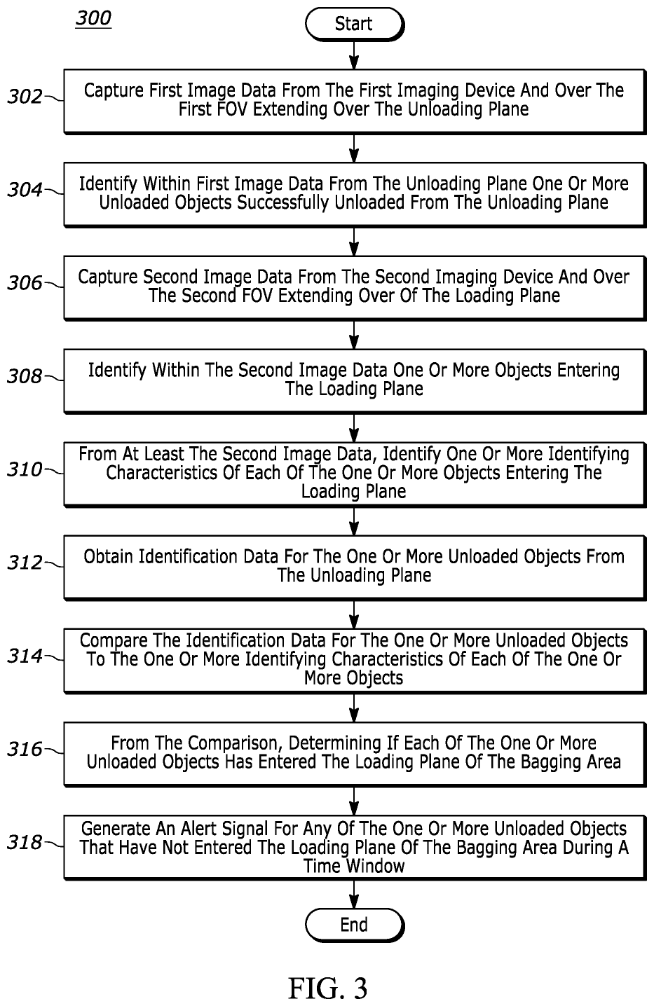

FIG. 3 illustrates an example product verification method 300, in accordance with embodiments disclosed herein. The method 300 includes capturing first image data from the first imaging device and over the first FOV extending over the unloading plane (block 302). The method 300 further includes identifying within the first image data from the unloading plane one or more unloaded objects successfully unloaded from the unloading plane (block 304). The method 300 may further include capturing second image data from the second imaging device and over the second FOV extending over the loading plane (block 306).

Moreover, the method 300 may include identifying within the second image data one or more objects entering the loading plane (block 308). The method 300 may further include identifying, from at least the second image data, one or more identifying characteristics of each of the one or more objects entering the loading plane (block 310). The method 300 may also include obtaining identification data for the one or more unloaded objects from the unloading plane (block 312).

The method 300 may further include comparing the identification data for the one or more unloaded objects to the one or more identifying characteristics of each of the one or more objects entering the loading plane (block 314). The method 300 may further include determining, from the comparison, if each of the one or more unloaded objects has entered the loading plane of the bagging area (block 316). The method 300 may also include generating an alert signal for any of the one or more unloaded objects that have not entered the loading plane of the bagging area during a time window (block 318). The time window may be any suitable time interval, such as five seconds, thirty seconds, one minute, two minutes, etc.

In certain embodiments, the housing of the second imaging device may be positioned to direct the second FOV to include as the loading plane an opening in a bag positioned in the bagging area. Further in these embodiments, the second imaging device may be a two-dimensional (2D) imaging camera for capturing 2D images as the image data. Additionally, or alternatively, the second imaging device may be a three-dimensional (3D) imaging camera for capturing 3D point cloud images as the image data. Moreover, in certain instances, the second imaging device may be a ranging time-of-flight (ToF) imager.

Further, in certain embodiments, the housing of the second imaging device may be positioned to direct the second FOV such that a bottom edge of the second FOV includes an opening threshold of a bag in the bagging area, or to include at least one of: (i) an entirety of the opening in the bag positioned in the bagging area, (ii) a bottom of a bag in the bagging area, or (iii) the loading plane and a scanning region of the checkout location. These orientations of the second FOV may be useful for scanning/verifying products as well as for monitoring the loading plane. For example, when the second FOV includes the bottom of the bag in the bagging area, the second imaging device may capture image data of items that are missed initially when the user places multiple items into the bag when the items in the bag shift during loading.

In some embodiments, the method 300 may further include collecting, by a radio frequency identification (RFID) transceiver, RFID data corresponding to an object entering the loading plane and/or unloaded from the unloading plane. In these embodiments, the method 300 may further include identifying the one or more identifying characteristics of each object from the image data and from the RFID data.

In certain embodiments, the housing of the first imaging device may be positioned to direct the first FOV to include the loading plane and the scanning region of the checkout location.

In some embodiments, obtaining the identification data for the one or more successfully unloaded objects successfully unloaded from the unloading plane, further includes: identifying, in the first image data over the first FOV, an indicia associated with an object unloaded from the unloading plane; attempting to decode the indicia; and in response to successfully decoding the indicia, determining the object in the unloaded from the unloading plane is successfully unloaded, and generating the identification data for the object.

In certain embodiments, the method 300 may further include receiving, from a scanning device having an imaging sensor with a third FOV directed at a scanning region of the checkout location and separate from the first imaging device and from the second imaging device, the identification data for the one or more successfully unloaded objects scanned at the scanning region. Further in these embodiments, the scanning region may substantially overlap with the loading plane.

In some embodiments, the method 300 may further include identifying the one or more identifying characteristics of each of the one or more objects entering the loading plane using an object recognition process. In certain embodiments, the method 300 may further include identifying the one or more identifying characteristics of each of the one or more objects entering the loading plane using a trained machine learning (ML) model (e.g., as part of the object identification module 206a).

In certain embodiments, the method 300 may further include detecting placement of a container in the unloading area. Further in these embodiments, the method 300 may further include determining, using a second weigh scale positioned in the bagging area of the checkout location, a total reduction in weight of the container during a weighing window of time. The method 300 may further include determining, using a first weigh scale positioned in an unloading area coinciding with the unloading plane of the checkout location the bagging area of the checkout location, a total increase in weight associated with the one or more objects entering the loading plane of the bagging area. The method 300 may further include comparing the total reduction in weight determined from the second first weigh scale to the total increase in weight determined from the first second weigh scale, and generating a successful weight transfer signal in response to the total increase in weight being within an acceptable range of the total reduction in weight. The method 300 may further include generating an unsuccessful weight transfer signal in response to the total increase in weight being outside the acceptable range of the total reduction in weight. Still further in these embodiments, the acceptable range may be +/−5%, +/−10%, and/or any other suitable range of values.

In some embodiments, the method 300 may further include capturing third image data from the second imaging device and over the second FOV extending over the loading plane. The method 300 may further include identifying within the second image data no objects entering the loading plane, and from at least the third image data, identifying one or more second identifying characteristics of each of the one or more objects that entered the loading plane. The method 300 may further include comparing the one or more second identifying characteristics to the one or more identifying characteristics to verify each of the one or more objects are successfully loaded.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAS, are specifically configured hardware for performing operations (e.g., one or more of the operations described herein and represented by the flowcharts of this disclosure, if such are present).

Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A multi-stage, product verification imaging system comprising:
a first imaging device having a first field of view (FOV) and a housing positioned to direct the first FOV at an unloading plane of a checkout location;
a second imaging device having a second FOV and a housing positioned to direct the second FOV to include a loading plane of a bagging area of the checkout location; and
one or more processors configured to;
capture first image data from the first imaging device and over the first FOV extending over the unloading plane;
identify within the first image data from the unloading plane one or more unloaded objects successfully unloaded from the unloading plane;
capture second image data from the second imaging device and over the second FOV extending over the loading plane;
identify within the second image data one or more objects entering the loading plane;
from at least the second image data, identify one or more identifying characteristics of each of the one or more objects entering the loading plane;
obtain identification data for the one or more unloaded objects from the unloading plane;
compare the identification data for the one or more unloaded objects to the one or more identifying characteristics of each of the one or more objects entering the loading plane;
from the comparison, determine if each of the one or more unloaded objects has entered the loading plane of the bagging area; and
generate an alert signal for any of the one or more unloaded objects that have not entered the loading plane of the bagging area during a time window.

2. The multi-stage, product verification imaging system of claim 1, wherein the housing of the second imaging device is positioned to direct the second FOV to include as the loading plane an opening in a bag positioned in the bagging area.

3. The multi-stage, product verification imaging system of claim 2, wherein the housing of the second imaging device is positioned to direct the second FOV such that a bottom edge of the second FOV includes an opening threshold of a bag in the bagging area, or to include at least one of: (i) an entirety of the opening in the bag positioned in the bagging area, (ii) a bottom of a bag in the bagging area, or (iii) the loading plane and a scanning region of the checkout location.

4. The multi-stage, product verification imaging system of claim 2, wherein the second imaging device includes a two-dimensional (2D) imaging camera for capturing 2D images as the second image data.

5. The multi-stage, product verification imaging system of claim 4, wherein the second imaging device further includes (i) a three-dimensional (3D) imaging camera for capturing 3D point cloud images as a portion of the second image data that is used to identify the unloading plane within the second FOV or (ii) a ranging time-of-flight (ToF) imager.

6. The multi-stage, product verification imaging system of claim 1, further comprising a radio frequency identification (RFID) transceiver configured to collect RFID data, wherein the processor is further configured to identify the one or more identifying characteristics of each object from the image data and from the RFID data.

7. The multi-stage, product verification imaging system of claim 1, wherein to obtain the identification data for the one or more unloaded objects successfully unloaded from the unloading plane, the processor is configured to:
identify, in the first image data over the first FOV, an indicia associated with an object unloaded from the unloading plane;
attempt to decode the indicia; and
in response to successfully decoding the indicia, determine the object unloaded from the unloading plane is successfully unloaded, and generate the identification data for the object.

8. The multi-stage, product verification imaging system of claim 1, wherein the processor is further configured to receive, from a scanning device having an imaging sensor with a third FOV directed at a scanning region of the checkout location and separate from the first imaging device and from the second imaging device, the identification data for the one or more unloaded objects scanned at the scanning region.

9. The multi-stage, product verification imaging system of claim 9, wherein the scanning region substantially overlaps with the loading plane.

10. The multi-stage, product verification imaging system of claim 1, wherein the processor is configured to identify the one or more identifying characteristics of each of the one or more objects entering the loading plane using (i) an object recognition process or (ii) a trained machine learning (ML) model.

11. The multi-stage, product verification imaging system of claim 1, further comprising:
a first weigh scale positioned in an unloading area coinciding with the unloading plane of the checkout location; and
a second weigh scale positioned in the bagging area of the checkout location,
wherein the one or more processors are configured to:
detect placement of a container in the unloading area;
determine, using the first weigh scale, a total reduction in weight of the container during a weighing window of time;
determine, using the second weigh scale, a total increase in weight associated with the one or more objects entering the loading plane of the bagging area;
compare the total reduction in weight determined from the first weigh scale to the total increase in weight determined from the second weigh scale; and
generate a successful weight transfer signal in response to the total increase in weight being within an acceptable range of the total reduction in weight, and generate an unsuccessful weight transfer signal in response to the total increase in weight being outside the acceptable range of the total reduction in weight.

12. The multi-stage, product verification imaging system of claim 1, wherein the unloading plane is disposed proximate to at least one of: (i) a top of a shopping basket, (ii) a top of a reusable bag, or (iii) a top of a shopping cart.

13. The multi-stage, product verification imaging system of claim 1, wherein the one or more processors are further configured to:
capture third image data from the second imaging device and over the second FOV extending over the loading plane;
identify within the second image data no objects entering the loading plane;
from at least the third image data, identify one or more second identifying characteristics of each of the one or more objects that entered the loading plane; and
compare the one or more second identifying characteristics to the one or more identifying characteristics to verify each of the one or more objects are successfully loaded.

14. A tangible machine-readable medium comprising instructions for product verification that, when executed, cause a machine to at least:
capture first image data from a first imaging device having a first field of view (FOV) including an unloading plane of a checkout location, the first imaging device including a first two-dimensional (2D) imaging camera for capturing 2D images as the first image data;
identify within the first image data from the unloading plane one or more unloaded objects successfully unloaded from the unloading plane;
capture second image data from a second imaging device having a second FOV including a loading plane of a bagging area of the checkout location, the second imaging device including a second 2D imaging camera for capturing 2D images as the second image data;
identify within the second image data one or more objects entering the loading plane;
from at least the second image data, identify one or more identifying characteristics of each of the one or more objects entering the loading plane;
obtain identification data for the one or more unloaded objects from the unloading plane;
compare the identification data for the one or more unloaded objects to the one or more identifying characteristics of each of the one or more objects entering the loading plane;
from the comparison, determine if each of the one or more unloaded objects has entered the loading plane of the bagging area; and
generate an alert signal for any of the one or more unloaded objects that have not entered the loading plane of the bagging area during a time window.

15. The tangible machine-readable medium of claim 14, wherein the instructions, when executed, further cause the machine to at least:
identify the one or more identifying characteristics of each object from (i) the image data and (ii) radio frequency identification (RFID) data collected by an RFID transceiver.

16. The tangible machine-readable medium of claim 14, wherein to obtain the identification data for the one or more unloaded objects successfully unloaded from the unloading plane, the instructions, when executed, further cause the machine to at least:
identify, in the first image data over the first FOV, an indicia associated with an object unloaded from the unloading plane;
attempt to decode the indicia; and
in response to successfully decoding the indicia, determine the object unloaded from the unloading plane is successfully unloaded, and generate the identification data for the object.

17. The tangible machine-readable medium of claim 14, wherein the instructions, when executed, further cause the machine to at least:
receive, from a scanning device having an imaging sensor with a third FOV directed at a scanning region of the checkout location and separate from the first imaging device and from the second imaging device, the identification data for the one or more unloaded objects scanned at the scanning region.

18. The tangible machine-readable medium of claim 14, wherein the instructions, when executed, further cause the machine to at least:
identify the one or more identifying characteristics of each of the one or more objects entering the loading plane using (i) an object recognition process or (ii) a trained machine learning (ML) model.

19. The tangible machine-readable medium of claim 14, wherein the instructions, when executed, further cause the machine to at least:
detect placement of a container in the unloading area;
determine, using a first weigh scale positioned in an unloading area coinciding with the unloading plane of the checkout location, a total reduction in weight of the container during a weighing window of time;
determine, using a second weigh scale positioned in the bagging area of the checkout location, a total increase in weight associated with the one or more objects entering the loading plane of the bagging area;
compare the total reduction in weight determined from the first weigh scale to the total increase in weight determined from the second weigh scale; and
generate a successful weight transfer signal in response to the total increase in weight being within an acceptable range of the total reduction in weight, and generate an unsuccessful weight transfer signal in response to the total increase in weight being outside the acceptable range of the total reduction in weight.

20. A computer-implemented product verification method comprising:
capturing first image data from a first imaging device having a first field of view (FOV) including an unloading plane of a checkout location;
identifying within the first image data from the unloading plane one or more unloaded objects successfully unloaded from the unloading plane;
capturing second image data from a second imaging device having a second FOV including a loading plane of a bagging area of the checkout location;
identifying within the second image data one or more objects entering the loading plane;
from at least the second image data, identifying one or more identifying characteristics of each of the one or more objects entering the loading plane;
obtaining identification data for the one or more unloaded objects from the unloading plane;
comparing the identification data for the one or more unloaded objects to the one or more identifying characteristics of each of the one or more objects entering the loading plane;
from the comparison, determining if each of the one or more unloaded objects has entered the loading plane of the bagging area; and
generating an alert signal for any of the one or more unloaded objects that have not entered the loading plane of the bagging area during a time window.
